(19) United States
(12) Patent Application Publication
(10) Pub. No.: US 2011/0111101 A1
(43) Pub. Date: May 12, 2011

(54) METHOD AND APPARATUS OF PACKAGING BEVERAGE MIXTURE

(75) Inventor: Sheldon E. Yourist, York, PA (US)

(73) Assignee: GRAHAM PACKAGING COMPANY, L.P., York, PA (US)

(21) Appl. No.: 12/614,105

(22) Filed: Nov. 6, 2009

(51) Int. Cl. A47J 43/27; B65D 25/04; B01F 13/00; A23L 2/00; B01F 15/00; A23P 1/00

(52) U.S. Cl. 426/232; 220/505; 366/130

(57) ABSTRACT

A method of making a beverage that needs to be agitated before drinking includes a first step of providing a container assembly having a main body portion that has a side wall that defines an interior space and an upper mounting portion to which a closure is releasably secured. The main body portion has a lower portion that is at least partially filled with a first substance, the lower portion defining a first volume, an upper head portion having a second volume and an agitator portion defined in the side wall between the lower portion and the upper head portion. The closure is removed, and a second substance is added to the container assembly. The closure is then replaced, and the container assembly is shaken by the consumer, which causes the agitator portion to promote mixing of the contents of the container assembly. The consumer will then drink at least a portion of the contents of the container assembly.

### BACKGROUND OF THE INVENTION

1. Field of the Invention

This invention relates generally to the field of consumer packaging, and more specifically to containers that are used to package a beverage mixture and to facilitate use of the beverage mixture by a consumer

2. Description of the Related Technology

A variety of beverage mixture materials such as dehydrated pastes, granules, powders or frozen material have been packaged for sale to consumers for eventual reconstitution into a beverage, soup or edible slurry.

Some mixture materials are packaged in such a manner that the consumer must remove the mixture material from the packaging and place it within a separate vessel or container for mixing with a liquid such as water or milk. This can be done by removing a portion of the mixture material from the packaging container using an implement such as a spoon, or by pouring it directly from the packaging after opening.

In other cases, the original packaging container has been constructed in a manner that will permit a liquid additive to be mixed with a liquid or other material while it is still in the original packaging. However, it has often challenging for the consumer to thoroughly mix the respective materials within the original packaging to the extent that is necessary to ensure optimal food or beverage quality.

Using an agitator such as a stir straw or a spoon can take an extended period of time to achieve the optimal amount of mixing. In addition, such an article may not be readily available. Shaking the container in order to mix the material in the liquid additive can also be limited in its effectiveness because the geometry of conventional containers is not optimized to promote mixture by shaking. Shaking some containers when a liquid is inside can also result in leakage from the container.

A need exists for an improved method and apparatus for packaging a beverage mixture that will permit thorough mixing of the beverage mixture with an additive material to be achieved within the original product packaging with minimal effort by the consumer and with minimal risk of leakage.

### SUMMARY OF THE INVENTION

Accordingly, it is an object of the invention to provide an improved method and apparatus for packaging a beverage mixture that will permit thorough mixing of the beverage mixture with an additive material to be achieved within the original product packaging with minimal effort by the consumer and with minimal risk of leakage.

In order to achieve the above and other objects of the invention, a container for packaging a beverage that needs to be agitated before drinking according to a first aspect of the invention includes a main body portion having a side wall that defines an interior space. The main body portion has an upper mounting portion defining an opening that is in communication with the interior space, and a closure member that is releasably securable to the upper mounting portion. The main body portion is shaped so as to define a lower portion having a first volume, an upper head portion having a second volume and an agitator portion defined in the side wall between the lower portion and the upper head portion. This facilitates amplified mixing of the contents of the container when the container is shaken by a consumer.

According to a second aspect of the invention, a method of making a beverage that needs to be agitated before drinking includes steps of providing a container assembly having a main body portion that has a side wall that defines an interior space and an upper mounting portion to which a closure is releasably secured. The main body portion has a lower portion that is at least partially filled with a first substance. The lower portion defines a first volume, an upper head portion having a second volume and an agitator portion defined in the side wall between the lower portion and the upper head portion. The closure will then be removed, and a second substance will be added to the container assembly. The closure will be replaced, and the container assembly will be shaken so that the agitator portion promotes mixing of the contents therein.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a perspective view of a portion of a container assembly that is constructed according to a preferred embodiment of the invention;

FIG. 2 is a perspective view of the container assembly shown in FIG. 1, with an additional component shown;

FIG. 3 is a diagrammatical depiction of one component of the container assembly that is shown in FIG. 1;

FIG. 4 is a top plan view showing one component of the container assembly that is shown in FIG. 1;

FIG. 5 is an enlarged view of one portion of the component that is shown in FIG. 3; and

FIG. 6 is a diagrammatical cross-sectional depiction of a side wall of the container.

### DETAILED DESCRIPTION OF THE PREFERRED EMBODIMENT(S)

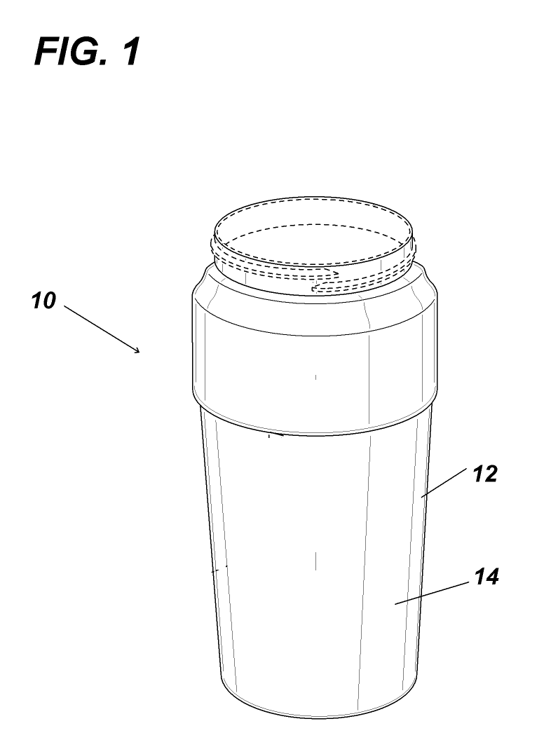

Referring now to the drawings, wherein like reference numerals designate corresponding structure throughout the views, and referring in particular to FIG. 1, a container assembly 10 that is constructed according to a preferred embodiment of the invention is designed for packaging a beverage or a beverage mixture component that needs to be agitated before drinking.

Container assembly 10 is designed to permit and facilitate thorough mixing of a mixture material with an additive within the original product packaging with minimal effort by the consumer and with minimal risk of leakage. The mixture material may be a powder, a granular material, a paste or a frozen material such as ice cream. The additive, which is preferably provided by the consumer, may be a liquid such as water or milk, a powder, a granular material, a paste or another frozen material. The term beverage as used herein shall be construed as including any type of edible liquid, liquid suspension or slurry material.

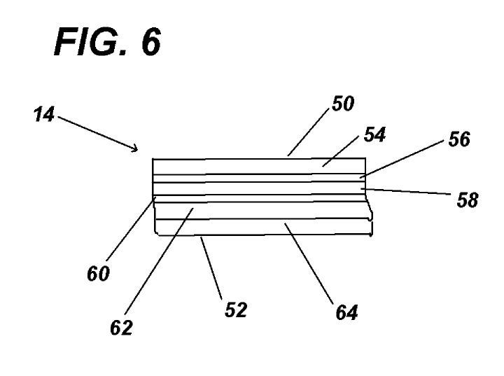

Container assembly 10 preferably includes a main body portion 12 having a side wall 14 that, as FIG. 6 shows, is preferably is a multi-layer structure having an oxygen barrier.

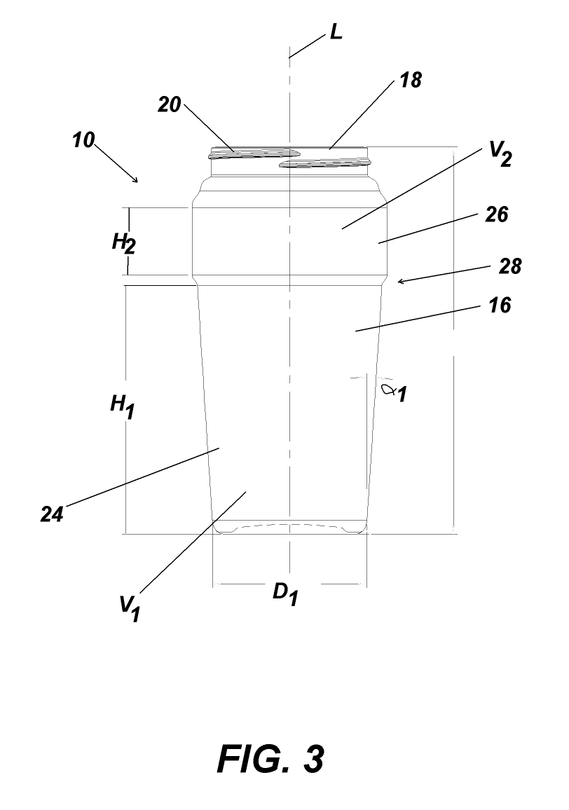

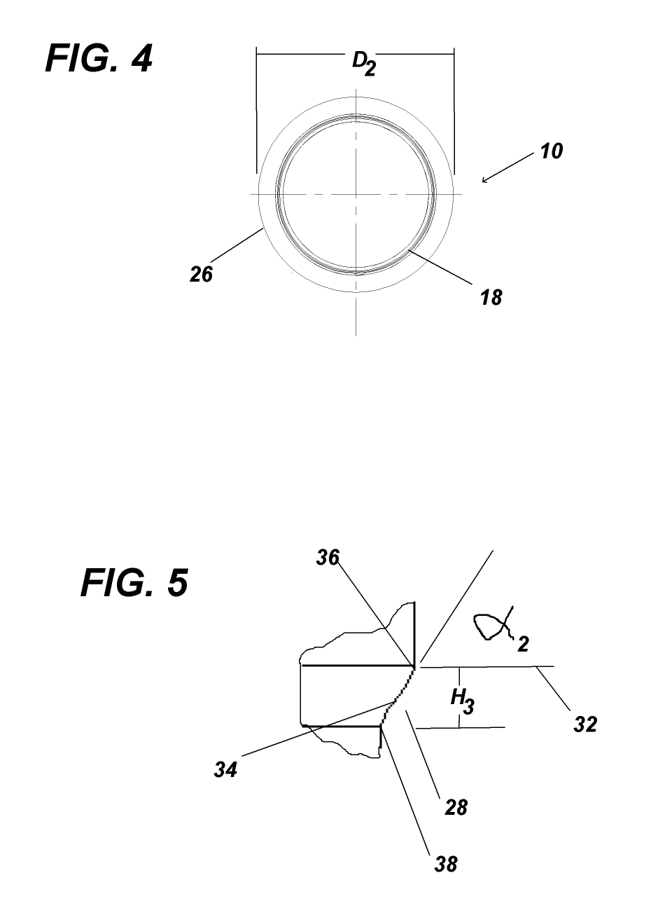

As FIG. 3 shows, the side wall 14 of the main body portion 12 defines an interior space 16, in which a beverage mixture material such as a powder, paste, granular or frozen material can be positioned during manufacturing and filling on the container assembly 10. The main body portion 12 further includes an upper mounting portion 18 that defines an upper container opening that is in communication with the interior space 16.

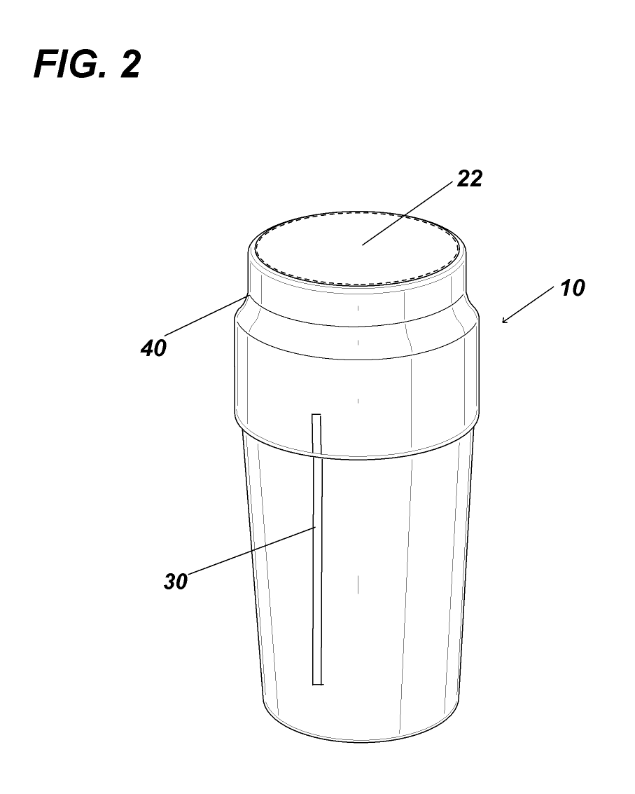

The upper mounting portion 18 in the preferred embodiment includes at least one helical thread 20 that is defined on a cylindrical outer surface thereof for permitting an internally threaded closure member 22, best shown in FIG. 2, to be releasably secured to the main body portion 12. In the preferred embodiment, closure member 22 is a closure cap that is constructed and arranged to completely seal the upper opening of the main body portion 12 when the closure cap is secured to the upper mounting portion 18.

Alternatively, the closure member could be constructed as a dispensing closure of conventional design that remains secured to the upper mounting portion 18 but that may be opened and closed by the consumer in order to selectively dispense the contents of the container assembly 10.

The main body portion 12 is preferably shaped so as to define a lower portion 24 that defines a first volume V₁ and an upper head space portion 26 that defines a second volume V₂. In addition, an agitator portion 28 is preferably defined in the side wall 14 between the lower portion 24 and the upper head space portion 26 for facilitating amplified mixing of the contents of the container assembly 10 when the container assembly 10 is shaken by a consumer.

In the preferred embodiment, a ratio of the second volume V₂ to the first volume V₁ is substantially within a range of about 0.47 to about 0.87, more preferably substantially within a range of about 0.52 to about 0.82 and most preferably substantially within a range of about 0.57 to about 0.77.

Preferably, the lower portion 24 of the main body portion 12 is substantially shaped as an inverted truncated cone. The upper head space portion 26 is preferably shaped substantially cylindrically.

Preferably, the lower portion 24 the lower portion has a first minimum lateral extent D₁, and the upper head space portion has a second maximum lateral extent D₂. The second maximum lateral extent D₂ is preferably greater than the first minimum lateral extent D₁. A ratio D1/D2 is preferably within a range of substantially about 0.40 to about 0.95, more preferably substantially about 0.50 to about 0.90 and most preferably substantially 0.65 to about 0.85.

The lower portion 24 has a first height H₁, and the upper end space portion 26 has a second height H₂. The agitator portion 28 has a third height H₃. The first height H₁ is preferably greater than both the second and third heights H₂, H₃, and the second height H₂ is preferably greater than the third height H₃. A ratio of the second height H₂ to the first height H₁ is preferably substantially within a range of about 0.10 to about 0.50, more preferably substantially within a range of about 0.15 to about 0.40, and most preferably substantially within a range of about 0.20 to about 0.35.

As is best shown in FIG. 5, the agitator portion 28 preferably includes an angled surface 34 that is defined within the side wall 14 between the lower portion 26 and the upper head space portion 28. The angled surface 34 is preferably angled with respect to a transverse plane 32 within a range that is substantially about 21° to about 81°, more preferably within a range that is substantially about 31° to about 71°, and most preferably within a range that is substantially about 41° to about 61°.

As FIG. 2 shows, the container assembly 10 may further be provided with an external wrapping 40 that provides a tamper-evident seal and a freshness seal for the contents of the container assembly 10. The external wrapping 40 may be a thin plastic shrink wrap material that is perforated for convenient removal by a consumer.

As is best shown in FIG. 1, the side wall 14 of the main body portion 12 is preferably translucent or transparent. In addition, as FIG. 2 shows, a translucent or transparent viewing window 30 may be defined in the shrink wrap material 40 for enabling a consumer to detect the fill level of the contents within the container assembly 10 through the shrink wrap material 40. The viewing window 30 may extend next to the lower portion 24, the upper portion 26 and the agitator portion 28, as FIG. 2 shows.

The side wall 14 of the main body portion 12 is shown diagrammatically in cross-section in FIG. 6. It includes a first, inside surface 50 that defines the interior space 16 of the main body portion 12, and a second outer surface 52. A first layer 54 forming the inner surface is preferably fabricated from virgin high density polyethylene (HDPE), while the second regrind layer 56 is fabricated from a mixture of virgin HDPE and recycled HDPE. The fourth oxygen barrier layer 60 is preferably fabricated from EVOH, and is adhered to the second layer 56 by a third adhesive layer 58 that is preferably a high density based adhesive. A sixth outer layer 64 of HDPE is adhered to the oxygen barrier layer 60 by an adhesive layer 62 that is preferably a high density based adhesive.

A method of making a beverage or edible slurry that needs to be thoroughly mixed before consumption according to a preferred embodiment of the invention includes a step of providing a container assembly 10 as described above. The container assembly 10 is preferably partially filled during manufacturing with a first beverage component material, which could be a dehydrated granular material, a powder material, a paste material, or a frozen material such as ice cream. In the preferred embodiment, the first beverage component material may fill approximately half of the first volume V₁ within the interior space 16.

The container assembly 10 is sealed during manufacturing through application of the closure member 22 and by the application of the shrink wrap material 40 shown in FIG. 2. It will then be distributed through commercial channels and eventually sold to the consumer.

The consumer will remove the shrink wrap material 40, remove the closure member 22 and add a predetermined amount of a second material, which could be a liquid, a powder or granular material, paste or frozen material, into the interior space 16 of the container assembly 10. He or she may monitor the total fill level within the interior space 16 by inspecting the viewing window 30. The closure member 22 is then replaced and secured on to the upper mounting portion 18 of the container assembly 10. The consumer will then shake the container assembly 10 in order to thoroughly mix the contents that are within the interior space 16. The presence of the large head space 26 promotes such thorough mixing of the contents with minimal shaking. In addition, the agitator portion 28 causes inward deflection of material within the interior space 16 that may contact it when the container assembly 10 is being shaken by the consumer. This also promotes thorough mixing of the contents of the container assembly 10 with minimal shaking.

After shaking, the consumer may then consume the beverage or edible slurry that he or she has created using the container assembly 10.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A container for packaging a beverage that needs to be agitated before drinking, comprising:
a main body portion having a side wall that defines an interior space, said main body portion having an upper mounting portion defining an opening that is in communication with the interior space;
a closure member that is releasably securable to the upper mounting portion; and wherein
the main body portion is shaped so as to define a lower portion having a first volume, an upper head portion having a second volume and an agitator portion defined in the side wall between the lower portion and the upper head space portion for facilitating amplified mixing of the contents of the container when the container is shaken by a consumer.

2. A container for packaging a beverage according to claim 1, wherein a ratio of the second volume to the first volume is substantially within a range of about 0.47 to about 0.87.

3. A container for packaging a beverage according to claim 2, wherein the ratio of the second volume to the first volume is substantially within a range of about 0.52 to about 0.82.

4. A container for packaging a beverage according to claim 3, wherein the ratio of the second volume to the first volume is substantially within a range of about 0.57 to about 0.77.

5. A container for packaging a beverage according to claim 1, wherein the lower portion of the main body portion is substantially shaped as an inverted truncated cone.

6. A container for packaging a beverage according to claim 1, wherein the upper head portion is substantially cylindrically shaped.

7. A container for packaging a beverage according to claim 1, wherein the lower portion has a first maximum lateral extent and the upper head portion has a second maximum lateral extent, and wherein the second maximum lateral extent is greater than the first maximum lateral extent.

8. A container for packaging a beverage according to claim 7, wherein the agitator portion comprises an angled surface defined within the side wall between the lower portion and the upper head portion, and wherein the angled surface is angled with respect to a transverse plane within a range that is substantially about 21° to about 81°.

9. A container for packaging a beverage according to claim 8, wherein the angled surface is angled with respect to the transverse plane within a range that is substantially about 31° to about 71°.

10. A container for packaging a beverage according to claim 9, wherein the angled surface is angled with respect to the transverse plane within a range that is substantially about 41° to about 61°.

11. A container for packaging a beverage according to claim 1, wherein the side wall comprises a multi-layer material having an oxygen barrier.

12. A container for packaging a beverage according to claim 1, wherein the side wall comprises a viewing window for enabling a consumer to detect a fill level within the container

13. A method of making a beverage that needs to be agitated before drinking, comprising:
providing a container assembly having a main body portion having a side wall that defines an interior space and an upper mounting portion to which a closure is releasably secured, the main body portion having a lower portion that is at least partially filled with a first substance, the lower portion defining a first volume, an upper head portion having a second volume and an agitator portion defined in the side wall between the lower portion and the upper head portion;
removing the closure;
adding a second substance to the container assembly;
replacing the closure; and
shaking the container assembly so that the agitator portion promotes mixing of the contents therein.

14. A method of making a beverage according to claim 13, wherein a ratio of the second volume to the first volume is substantially within a range of about 0.47 to about 0.87.

15. A method of making a beverage according to claim 14, wherein the ratio of the second volume to the first volume is substantially within a range of about 0.52 to about 0.82.

16. A method of making a beverage according to claim 15, wherein the ratio of the second volume to the first volume is substantially within a range of about 0.57 to about 0.77.

17. A method of making a beverage according to claim 13, wherein the lower portion of the main body portion is substantially shaped as an inverted truncated cone.

18. A method of making a beverage according to claim 13, wherein the upper head portion is substantially cylindrically shaped.

19. A method of making a beverage according to claim 13, wherein the lower portion has a first maximum lateral extent and the upper head portion has a second maximum lateral extent, and wherein the second maximum lateral extent is greater than the first maximum lateral extent.

20. A method of making a beverage according to claim 19, wherein the agitator portion comprises an angled surface defined within the side wall between the lower portion and the upper head portion, and wherein the angled surface is angled with respect to a transverse plane within a range that is substantially about 21° to about 81°.

21. A method of making a beverage according to claim 20, wherein the angled surface is angled with respect to the transverse plane within a range that is substantially about 31° to about 71°.

22. A method of making a beverage according to claim 21, wherein the angled surface is angled with respect to the transverse plane within a range that is substantially about 41° to about 61°.

23. A method of making a beverage according to claim 13, wherein the side wall comprises a multi-layer material having an oxygen barrier.

24. A method of making a beverage according to claim 13, wherein the side wall comprises a viewing window for enabling a consumer to detect a fill level within the container assembly, and further comprising a step of determining a fill level within the container assembly by inspecting the viewing window.
